(19) United States
(12) Patent Application Publication
(10) Pub. No.: US 2025/0094701 A1
(43) Pub. Date: Mar. 20, 2025

(54) Intelligent Automated Creation of Electronic Data Exchange Templates for Telecommunication Expense Management Inventory Processing

(71) Applicant: Tangoe US, Inc., Stamford, CT (US)

(72) Inventor: Jigar Madlani, Oxfordshire (GB)

(21) Appl. No.: 18/884,982

(22) Filed: Sep. 13, 2024

Related U.S. Application Data
(60) Provisional application No. 63/538,866, filed on Sep. 18, 2023.

(51) Int. Cl. G06F 40/186; G06F 40/103; G06Q 10/087

(52) U.S. Cl. CPC G06F 40/186; G06F 40/103; G06Q 10/087

(57) ABSTRACT

A system is provided that uses template files to process EDI invoice files to extract inventory related data which can both augment existing inventory data as well as validate its accuracy. The system also provides automated means to map new carrier EDI formats to new templates which can be created in an automated fashion through the use of machine learning and robotic process automation.

### FIELD OF THE INVENTION

The present invention relates to systems and methods for extracting inventory information from billing data received from telecommunications carriers using electronic data interchange (EDI) files. Templates for processing the carrier specific EDI files using machine learning are created and used, which evolve using machine learning to encompass new file formats dynamically creating templates for these. When information is missing, the system leverages previously validated templates to find matches which are used to stitch together a new template. The end goal is to obtain and augment telecom inventory data from the telecom invoices in an automated manner and to apply machine learning to create the templates automatically as carriers are added to the system.

### BACKGROUND OF THE INVENTION

Many telecom expense management companies offer services that include both invoice processing and inventory management. These are two systems out of many that make up an offering for clients that may use the services of a TEM provider.

One of the challenges in such systems is the maintenance of up-to-date records for the inventory of telecommunications devices. Due to the nature of these systems being mission critical, when problems occur, those affected may go to any length to resolve the problems often paying out of pocket to bring in replacements, rerouting, or redeploying systems from other parts of the company to handle more urgent needs, or simply buying new systems to replace the units have been affected.

An executive on a business trip that drops their phone shattering the screen will not wait to get back to open an IT ticket, they will likely head to the nearest store and buy a device and put in their SIM so they can continue working. A remote worker that damages their phone and does not want to report it may simply buy a replacement. These are but a few examples.

The subsequent update of inventory systems to reflect these types of changes is rarely done as once the systems are back online there is a backlog of urgent activity that was neglected that must be tackled. Users do not necessarily prioritize following up with IT or updating the system to reflect the changes.

This can lead to numerous issues such as off-the-books equipment being deployed and what some refer to as shadow-IT. Inventory costs may have been expensed and not properly allocated nor properly handled for amortization. Further, faulty equipment no longer used may be lying dormant, while invoices continue to come in and get paid when these services could and should be terminated.

The integration and processing of the EDI files from each carrier can also be laborious and complex as well as error prone.

U.S. Pat. No. 7,860,221 by Atkinson from AT&T describes a system to keep inventory data up to date which involves querying the devices directly. This system does not augment the inventory data files with information that is gathered from the invoices and may not recognize equipment which is still active and reachable but no longer being utilized.

U.S. Pat. No. 9,646,284 by Lew from Goldman Sachs describes a global system of inventory gathered by multiple sources however Lew does not teach about being able to generate templates and automate this template creation using machine learning.

U.S. Pat. No. 9,690,770, by Desai from Oracle describes a system for parsing various data files, including proprietary formats for the processing, and analyzing of these using templates, however Desai does not look at the relationship between data types when extracting data and does not apply machine learning to automatically create new templates from other existing template files.

Accordingly, it would be beneficial to have a system that can utilize a template-based processing system to read EDI files from multiple carriers to extract and obtain inventory related data.

It would further be beneficial to have a system that could normalize the EDI invoice related data into inventory related data that can augment the inventory database as well as validate the existing inventory data.

It would still further beneficial to have a system that could automatically match existing templates to new EDI file formats for new carriers that are integrated into the system creating either complete templates where data matches can be made from existing templates or as complete a template as possible with the existing data. With machine learning and a larger pool of templates it is envisioned that such a system could match all fields regularly as the repository of templates grows over time.

Therefore, a need exists for a system and method to parse EDI files using templates and to automate the template creation for new carrier files.

### SUMMARY OF THE INVENTION

Accordingly, it is desired to provide a system and method that is able to process EDI file formats using a template to extract data that can be used for augmenting and maintaining inventory data files.

While inventory files are used as examples in the patent application this is not meant to be limiting, it can be envisioned that such a system could also be used to look at maintenance and service records, accounting reconciliation, human resource systems, and other applications that can benefit from any of the data extracted from EDI files used for billing.

Further still, EDI files used for applications other than billing or any files using a structured file format such as EDI could be processed using the same or similar template-based approach and thus a similar system implemented to learn and automatically create new templates could be created.

It is also desired to provide a system and method that is able to manage a group of templates for multiple carriers to match their EDI formats and maintain such templates if and as any of the carrier specific EDI formats change. The repository of templates is maintained by the system and kept up to date.

It is still further desired to provide a system and method that can utilize the repository of existing templates to match new EDI formats for new carriers such that a percentage match can be generated. As an example, an existing template may be found to be an 80% match for a new carrier indicating that 80% of the data in the new EDI format can be recognized and mapped using such a template.

It is still further desired to provide a system that leverage multiple partially matched templates in the existing repository to create a new template with a larger percentage match than any one single existing template. Again, as an example, if one template is found with an 80% match, but another if found with a 20% match, it may be found that some of the 20% match is not directly equivalent or contained in the 80% match. If an additional 5% of fields are discovered using the second template, a new template can be created that provides an 85% match.

It is still further desired to provide a system that can apply machine learning and to suggest matched to fields that are not directly matched in the templated to simplify and further reduce the effort involved in coming up with a 100% match template. This can be done by matching fields names, using a process of elimination for remaining fields. As an example, if the format of a field is a date, and there is only a single date item missing to complete the template it is with a large likelihood that the missing field can be mapped to the date fields.

Finally, it is desired to provide a system and method that can apply machine learning to match using a growing number of templates as these are added such that 100% of the fields can be matched and the new template that matches all the fields can be added to the system in an automated fashion.

In one configuration, a template is created and used to match EDI file data to generate an output file containing attributes that can be consumed by an inventory system and stored in a database table and/or a comma delimited file.

In another configuration a system is provided that can match existing templates from a repository to a new EDI file.

In yet another configuration, a system that can utilize machine learning to suggest matches or automatically match fields from the EDI to the resultant output file is provided. This system can drastically reduce the template creation process by providing the closed match from the existing templates available.

In yet another configuration the system can stitch together a new template file from multiple existing templates in the repository of templates such that all of the fields are matches and the template can be created.

In yet another example a device may have malfunctioned, and a new device integrated into the system with the plan to repair the existing device, but no action was taken, and this old device is still being paid for and maintained.

The template-based processing makes it possible and viable to read the EDI files as they come in and match and validate the inventory data.

A system using machine learning and intelligence is used to match fields and help in the creation of templates using a process of elimination and heuristics for matching that are improved over time.

As the first templates are created the system learns how to better match and the recommended matches and automated matching algorithms improve.

Once the repository of templates grows, the ability to find existing matched from previously processed EDI file formats also grows allowing the system to find matches in the existing template files. The system can then propose a template that is the most complete or best partial match as a starting point for the new EDI file format.

Further the system can also look for matches across the whole repository of files and extract the existing matches fields by field to create a complete or partially complete template for the new carrier.

It is envisioned that as the repository grows, the matching will result in 100% matching most of the time.

In one example, a new carrier is to be added to the system and it provides a new format of EDI file that does not integrate with the system for extracting the data for inventory. The EDI file is analyzed by the system and compared with the repository of growing templates to create a new template to parse and process that data.

In another example, an EDI file format changes when a carrier adds new features to the system. Some carriers are more forthcoming and proactive in communicating these changes to third party integrators whereas others are not. Error detection and validation of the files is done post processing to determine if the EDI file has changed and new fields added that are not mapped or known in the template. In such cases, a template mismatch is confirmed, and the new template format is treated as a new file through the normal processing where the system applied machine learning to match new fields with other existing templates, and adjusts, essentially creating a new template. In most cases such as this, a minimal number of new fields are added, and the prior template serves as the starting point to build upon to create the new template.

In yet another example, the inventory file changes (a new location is opened, a location is closed, a new shipping method is added, a new device is available) and the definition and nomenclature referring to these names must be introduced. A new location code may be identified in the EDI file using the template, and machine learning can with confidence associate the new code found with the new location. In other cases, the template file can be modified ahead of time to note the new location codes. The same applies to inventory items and other variables that may be read in the EDI file.

For this application the following terms and definitions shall apply:

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “process” and “processing” as used herein each mean an action or a series of actions including, for example, but not limited to, the continuous or non-continuous, synchronous, or asynchronous, routing of data, modification of data, formatting and/or conversion of data, tagging or annotation of data, measurement, comparison and/or review of data, and may or may not comprise a program.

The term “customer” as used herein means any company, user, or third party receiving a service from a provider, for which an established contract with the Telecommunications Expense Management company has been negotiated for which EDI based invoices are received and processed.

The term “Carrier” as used herein means any entity such as a service provider, a manufacturer, or a 3^{rd} party, or other entity providing and EDI format of invoice including telecommunications data.

In one configuration a system for parsing EDI files using a template is presented

In another configuration, a method for generating new templates from EDI files is presented.

In either case, the association of the data received with contextual EDI fields are mapped to a generic normalized version of inventory data used by the system.

In certain aspects a system for mapping Electronic Data Interchange (EDI) files containing telecommunications data is provided comprising executing on a computer, the software having a plurality of templates accessible thereto, each of the plurality of templates containing mapping instructions for mapping a plurality of data fields comprising telecommunications data, the data fields contained in one or more EDI files. The accesses an EDI file and identifying mapping instructions from two or more of the plurality of templates which allow for mapping different sets of data fields in the EDI file wherein each of the two or more templates allows mapping a different subset of the EDI file. The software generating a new template from the identified mapping instructions from the two or more of the plurality of templates which allow for mapping of more of the EDI file than fewer than all of the two or more templates.

In other aspects the new template allows mapping of all data fields in the EDI file. In yet further aspects two or more templates allow for mapping of some data fields which are identical and some data fields with are different. In still further aspects the computer is connected to a network and receives the EDI file from a telecommunications provider. In other aspects the EDI file includes data related to: one or more device identifiers, usage associated with said one or more device identifiers and a phone number. In yet other aspects the mapping instructions include an aggregator string. In yet further aspects the software generates an output file based on the new template to convert the EDI file from a telecommunications provider format to a uniform format. In yet other aspects the one or more templates includes at least three templates and each template includes mapping instructions for a portion of the EDI file that others of the at least three templates do not include.

In still other aspects a system for mapping Electronic Data Interchange (EDI) files containing telecommunications data is provided including software executing on a computer, the software having a plurality of templates accessible thereto, each of the plurality of templates containing mapping instructions for mapping a plurality of data fields comprising telecommunications data, the data fields contained in one or more EDI files, each template associated with at least one telecommunications provider. The software accesses an EDI file from a first telecommunications provider and matching one of the plurality of templates to that EDI file, said software further identifying one or more data fields in the EDI file for which the template does not include mapping instructions. The software further includes a robotic process automation (RPA) which identifies one or more standard fields which are not mapped by the matched one of the plurality of templates and comparing the EDI file to those one or more standard fields to identify a correlation between the one or more standard fields and the one or more data fields in the EDI file for which the template does not include mapping instructions to generate augmentation data. The software further modifies the matched one of the plurality of templates or based on the augmentation data include additional mapping instructions for the identified one or more data fields in the EDI file for which the template did not include mapping instructions prior to modification.

In certain aspects upon modification, the matched one of the plurality of templates allows mapping of all data fields in the EDI file. In other aspects the standard field is associated with a uniform format for storage of data from the EDI file in a storage accessible to the computer. In other aspects the computer is connected to a network and receives the EDI file from a telecommunications provider. In still other aspects the EDI file includes data related to: one or more device identifiers, usage associated with said one or more device identifiers and a phone number. In yet other aspects the mapping instructions include an aggregator string. In still other aspects the software generates an output file based on the new template to convert the EDI file from a telecommunications provider format to a uniform format.

In other aspects a method is provided for converting Electronic Data Interchange (EDI) data to a uniform format comprising one or more steps of: accessing one or more EDI files each EDI file associated with one of a plurality of carriers; identifying a template for each of the one or more EDI files using software executing on a computer, the identified template including mapping instructions for the one of the plurality of telecommunications providers associated with the EDI file to map data fields in the EDI file to a uniform format; with the software, determining one or more data fields for which the identified template does not contain mapping instructions; with the software, obtaining additional mapping instructions from the group consisting of: one or more templates other than the identified template, a robotic process automation (RPA) which identifies one or more standard fields which are not mapped by the matched one of the plurality of templates and comparing the EDI file to those one or more standard fields to identify a correlation between the one or more standard fields and the one or more data fields use of a robot and combinations thereof; with the software, modifying the identified template to include the additional mapping instructions. In certain aspects the software accomplishes all steps. In certain aspects the computer is connected to a network and receives the EDI file from a telecommunications provider. In yet other aspects upon modification, the matched one of the plurality of templates allows mapping of all data fields in the EDI file. In certain aspects the mapping instructions include an aggregator string. In still other aspects the EDI file includes data related to: one or more device identifiers, usage associated with said one or more device identifiers and a phone number.

Other objects of the invention and its features and advantages will become more apparent from consideration of the following drawings and accompanying detailed description.

### BRIEF DESCRIPTION OF THE DRAWINGS

FIG. 1A is a functional flow of the components in the system.

FIG. 1B is a process flow diagram according to FIG. 1B.

FIG. 2 is a view of how a new EDI format file overlaps existing templates.

FIG. 3 is a view of the system processing an input EDI file with a template file and a resultant output file.

FIG. 4. Is a view of the system processing data and mapping it to expected results raising flags to audit functions and auto correcting the inventory data from the bill data received.

### DETAILED DESCRIPTION OF THE INVENTION

Referring now to the drawings, wherein like reference numerals designate corresponding structure throughout the views.

The following examples are presented to further illustrate and explain the present invention and should not be taken as limiting in any regard.

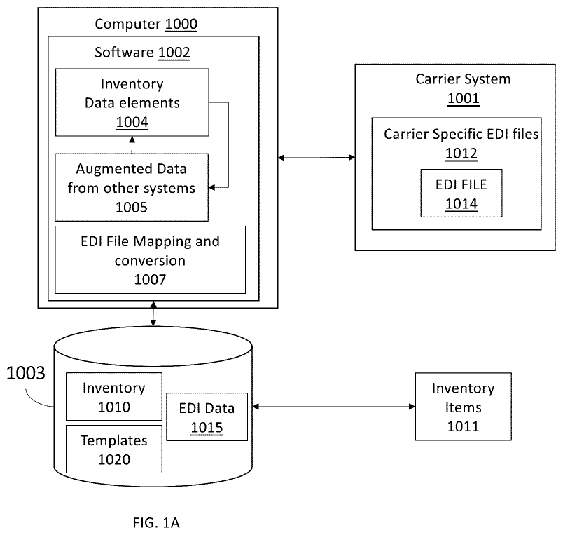

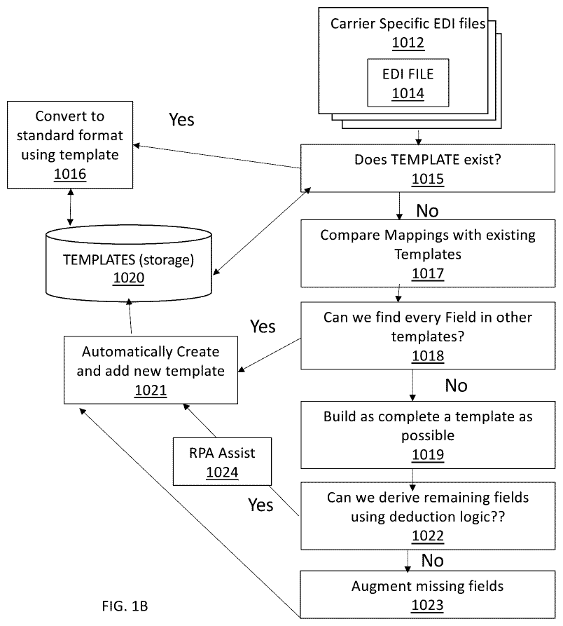

Referring to FIGS. 1A and 1B, the system computer 1000 includes software 1002 executing thereon. The software manages inventory data elements 1004 and augmented data obtained from other systems 1005 with potentially various other data from storage 1010 (or other external systems) in order to generate a complete list of inventory items 1011 that are maintained and verified with the data matched from EDI files 1012. The software 1002 further provides for EDI file mapping for conversion to standard or uniform formats from carrier specific EDI file 1014 formats. This conversion/normalization is accomplished using various templates 1020 of the storage 1003 for mapping of data which the software then uses that template to convert/store in the uniform format. The EDI files 1012 contain telecommunications data such as one or more of minutes used, data used, device type, plan information, owner information, line (e.g. phone number), call logs, SMS used and a variety of other fields used in the telecommunications industry both by carriers and TEM providers.

The carrier system 1001 includes Carrier specific EDI files 1012 including EDI files 1014 which are read by the system. The system attempts to use a template 1020 for the carrier file in question. If a template 1020 exists 1015 then the known template 1020 is used to fully process the EDI file 1014 in question and the output file is generated from the template 1016 and the data mapped to the inventory elements 1004 and updated or flagged if discrepancies exist where mapping instructions are not available in a single template for all data in the EDI file in question that needs mapping.

If no template exists 1017 the system compares existing templates 1018 to see if a new template can be created 1021 which is then added to the templates repository 1020 and again the output file is generated from the template 1016 and mapped to the inventory elements 1004. Augmented data 1005 obtained from the new EDI template 1021 can also be added to the inventory data elements 1004.

If all the fields cannot be mapped with existing templates 1019 when there are discrepancies, deduction logic and machine learning are used via a robotic process automation (RPA) 1024 to come up with the remaining fields to complete the template 1021 again after which the same steps of storing the new template 1020 and using it to create an output file 1016 which maps to the inventory data elements 1004 is used.

If it is not possible to automatically deduce the remaining fields, the fields can be augmented 1023 with suggestions for confirmation by a user to complete the template. The machine learning is also further trained in monitoring the user responses to improve its abilities to suggest and match future fields.

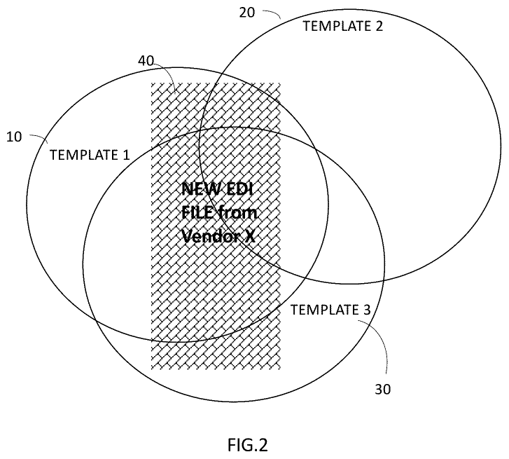

Referring to FIG. 2 a high-level view of the mapping of fields from various individual templates 10,20,30 of the templates 1020 to a new EDI file format 40 is shown in a graphical format. Consider the EDI file 40 with a multitude of fields. Here, each “brick” represents a data field. As shown the first template 10 overlaps a large number of these fields but is still missing some of them (in the visualization, the top right corner of the data and the bottom of the data). The third template 3 also overlaps much of the data and includes the fields shown in the bottom of the EDI file 40 visualization but is missing the top (which was included already in first template 10). Thus far, a good part of the EDI format is covered and understood by the system using the first and third templates. The remaining top right corner of the visualization is included in the second template which covers some of the same fields as the first and third templates. The system by taking the definitions of the three templates can now generate a template specific for the new EDI format 40 which has all of the fields in the new format understood and mapped. It is understood that the brick pattern is used for visualization of the EDI template overlapping, but that the EDI file would not look like bricks, rather the bricks represent various data fields which may be instead provided in a variety of data formats and organizations. As seen, by including all three templates 10, 20, 30 in the identification process, the full EDI file can be recognized and mapped and converted into a uniform format with is standard or normalized across all carriers. That normalized data is stored in the storage with the computer 1000 and may be used to update the inventory data 1010 or may itself contain the inventory data 1010.

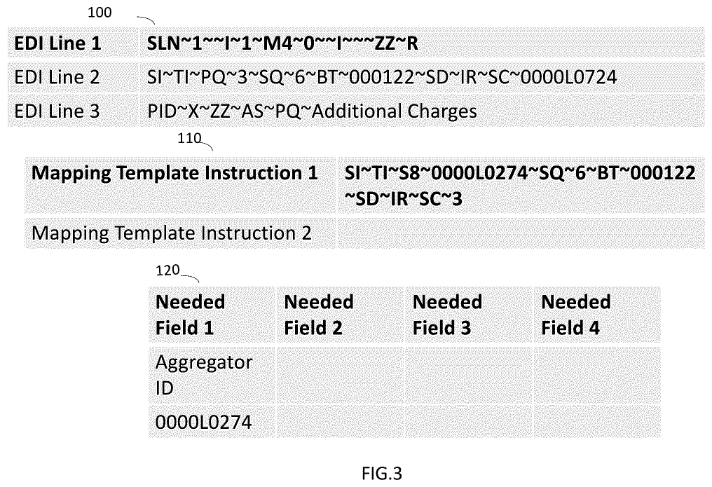

Referring to FIG. 3 a high-level view of the mapping tables is shown where the source EDI file 100 is shown with a line-by-line representation, the template file 110 is shown with one of many possible instruction sets to process the input file, and the output file 120 is shown with the resultant line from the given template instruction as it processed the input file 100. The line: SI˜TI˜S8˜0000L0274˜SQ˜6˜BT˜000122˜SD˜IR˜SC˜3 specifies that we should take the value of third qualifier 0000L0274 and populate the destination fields aggregator_id with this value in the resultant output file to provide the mapping instructions, as one example.

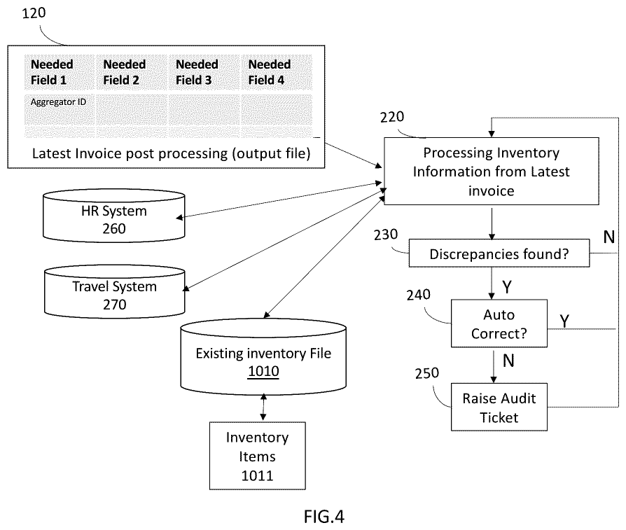

Referring now to FIG. 4 a high-level view of the inventory update mechanism is shown whereas the output file 120 is now processed 220 by the system 220 which looks at the existing inventory file 1010 and individual items 1011 mapping the values read to the data that comes in from the newly processed output file 120. If discrepancies are found 230 the system will attempt to autocorrect them 240 and if it cannot then it will raise an audit ticket 250 for intervention. The output file is processed field by field in this manner.

Aggregator language may be used in the template file specifying which fields and positions in the EDI file being processed are to be extracted to obtain the necessary information by the system.

As an example, a aggregator string such as h5˜SI=03:01=TI:02-S8!Aggregator_ID is used where we are defining to extract the 3^{rd} qualifier from the SI segment (“SI=03:01” in this example) at HL5 (“h5” in this example) when the 1^{st} qualifier is TI and 2^{nd} qualifier is S8 (“01=TI:02=S8” in this example) and the output is then mapped to the field of Aggregator ID in the output file. Each field required to be extracted from the file is mapped to a field such as Aggregator ID in the above, and the configuration of where to find the qualifiers in the EDI file are shown accordingly.

The EDI template processing system is provided to read the EDI invoice information monthly as invoices are created. The data extracted from the system is used to validate inventory data as well as augment it using data on the invoice that may not be present in the inventory system itself such as information on location, cost, users, and more. Using a secondary source of data such as the EDI data that is released by the carrier monthly is generally a better reference to validate data as other inventory systems may not reflect existing inventory accurately. While one may question which system to rely on when discrepancies arise, recognizing these and generating alerts that can lead to further verification is already a step ahead of many systems that leave such items undetected. Again, these scenarios may lead to excess billing for unneeded or unused inventory and expense optimization can be obtained by employing such a system.

Further, other functions on an inventory system may involve generating service calls and maintenance and the system may inadvertently be generating further expenditures towards circuits or inventory that is not used or needed.

A template system is created utilizing a field value combination which allows the template to be used to parse the EDI file from a specific vendor. Returning to the example of h5˜SI-03:01=TI:02=S8!Aggregator_ID, we are defining to extract the 3^{rd} qualifier from the SI segment at HL5 when the 1^{st} qualifier is TI and 2^{nd} qualifier is S8 and the output is then mapped to the field of Aggregator_ID in the output.

Using the template, the system is able to read the monthly invoices, generate an output file in a consistent and normalized format (such that all carriers, regardless of their specific EDI format input file have the identical output file that is used for updating and comparing the inventory files.

Devices and inventory are matched for accuracy with any discrepancies such as missing devices, new devices not present. This matching is done to the model number. Location data is also obtained from the invoice and can be used to detect the movement of devices in inventory. Further augmented information such as usage statistics and other data can be obtained from the inventory to also complement the existing inventory data. Other systems may also be used to query the devices directly to gather status or version information, expense processing systems to look for IT related expenses relating to these devices.

As an example, in one instance a device may no longer be used. The system may see a volume of data that is being billed and raise an alert for the audit team to verify or flag it as an unused device which should be decommissioned. In other cases, the device may be roaming or have some specific features manually turned on that adjusted the billing and thus it is a valid additional charge. In many cases, the devices being processed are fixed line devices and the variable charges may be more limited than mobile devices.

As another example, a user may setup a white 64 GB phone and 1 year later switch to a Samsung device. With the EDI information we extract the data we see that the data around the device model has changed. The billing data may also include a onetime fee for a device change which the system can either refer to audit or validate as an appropriate charge. The inventory data is updated based on what is read from billing info if the inventory data did not match the new device, as for example, the device may have been procured outside the normal procurement system processes.

In a typical scenario, the user would use the procurement system to order a new device, and this would automatically update the inventory data and flag the prior device as no longer in use and unless it's been reallocated the system would treat additional billing information beyond the first month as inappropriate and raise this to the audit function. If the prior device was not decommissioned, the system may also do so automatically to prevent subsequent charges. If the system sees the device allocated to another individual however, it may raise an audit line item to validate that the device was indeed passed on to a new employee for example.

For wired plans and devices such as switches, handsets, an example may be that of a switch installed at an office complex which was subsequently shut down and closed. If going forward charges for the switch continued the system would decommission the switch and raise a flag for audit.

Returning for a moment to previous example highlighted, corrections may be those items that are sufficiently self-explanatory such as the removal of a device when a newly allocated device has been procured for a user. It may be the addition of roaming charges when the system is able to reconcile travelling from the travel booking system 270, or the upgrade of a data plan when a promotion was received and read from the HR 260 system file.

The present systems and methods disclosed herein in some aspects provide for modifying a template, for example to enable processing and saving the EDI file and its associated data. By modifying the template this can include both modification of the template file/data and/or creation of new template files/data which include the original template information and the modifications. The modified template may be saved to overwrite the original template or may be modified and then saved as a new template in the storage 1003. The modification may be, for example, to add information to the template, modify existing information and combinations thereof.

Although the invention has been described with reference to a particular arrangement of parts, features, and the like, these are not intended to exhaust all possible arrangements or features, and indeed many other modifications and variations will be ascertainable to those of skill in the art.

What is claimed is:

1. A system for mapping Electronic Data Interchange (EDI) files containing telecommunications data comprising:
software executing on a computer, the software having a plurality of templates accessible thereto, each of the plurality of templates containing mapping instructions for mapping a plurality of data fields comprising telecommunications data, the data fields contained in one or more EDI files;
the software accessing an EDI file and identifying mapping instructions from two or more of the plurality of templates which allow for mapping different sets of data fields in the EDI file wherein each of the two or more templates allows mapping a different subset of the EDI file;
said software generating a new template from the identified mapping instructions from the two or more of the plurality of templates which allow for mapping of more of the EDI file than fewer than all of the two or more templates.

2. The system of claim 1 wherein the new template allows mapping of all data fields in the EDI file.

3. The system of claim 1 wherein two or more templates allow for mapping of some data fields which are identical and some data fields with are different.

4. The system of claim 1 wherein the computer is connected to a network and receives the EDI file from a telecommunications provider.

5. The system of claim 1 wherein the EDI file includes data related to: one or more device identifiers, usage associated with said one or more device identifiers and a phone number.

6. The system of claim 1 wherein the mapping instructions include an aggregator string.

7. The system of claim 1 further comprising said software generating an output file based on the new template to convert the EDI file from a telecommunications provider format to a uniform format.

8. The system of claim 1 wherein the one or more templates includes at least three templates and each template includes mapping instructions for a portion of the EDI file that others of the at least three templates do not include.

9. A system for mapping Electronic Data Interchange (EDI) files containing telecommunications data comprising:
software executing on a computer, the software having a plurality of templates accessible thereto, each of the plurality of templates containing mapping instructions for mapping a plurality of data fields comprising telecommunications data, the data fields contained in one or more EDI files, each template associated with at least one telecommunications provider;
the software accessing an EDI file from a first telecommunications provider and matching one of the plurality of templates to that EDI file, said software further identifying one or more data fields in the EDI file for which the template does not include mapping instructions;
said software further comprising a robotic process automation (RPA) which identifies one or more standard fields which are not mapped by the matched one of the plurality of templates and comparing the EDI file to those one or more standard fields to identify a correlation between the one or more standard fields and the one or more data fields in the EDI file for which the template does not include mapping instructions to generate augmentation data;
said software modifying the matched one of the plurality of templates or based on the augmentation data include additional mapping instructions for the identified one or more data fields in the EDI file for which the template did not include mapping instructions prior to modification.

10. The system of claim 9 wherein upon modification, the matched one of the plurality of templates allows mapping of all data fields in the EDI file.

11. The system of claim 9 wherein the standard field is associated with a uniform format for storage of data from the EDI file in a storage accessible to the computer.

12. The system of claim 9 wherein the computer is connected to a network and receives the EDI file from a telecommunications provider.

13. The system of claim 9 wherein the EDI file includes data related to: one or more device identifiers, usage associated with said one or more device identifiers and a phone number.

14. The system of claim 9 wherein the mapping instructions include an aggregator string.

15. The system of claim 9 further comprising said software generating an output file based on the new template to convert the EDI file from a telecommunications provider format to a uniform format.

16. A method of converting Electronic Data Interchange (EDI) data to a uniform format comprising:
accessing one or more EDI files each EDI file associated with one of a plurality of carriers;
identifying a template for each of the one or more EDI files using software executing on a computer, the identified template including mapping instructions for the one of the plurality of telecommunications providers associated with the EDI file to map data fields in the EDI file to a uniform format;
with the software, determining one or more data fields for which the identified template does not contain mapping instructions;
with the software, obtaining additional mapping instructions from the group consisting of: one or more templates other than the identified template, a robotic process automation (RPA) which identifies one or more standard fields which are not mapped by the matched one of the plurality of templates and comparing the EDI file to those one or more standard fields to identify a correlation between the one or more standard fields and the one or more data fields use of a robot and combinations thereof;
with the software, modifying the identified template to include the additional mapping instructions.

17. The system of claim 16 wherein the computer is connected to a network and receives the EDI file from a telecommunications provider.

18. The system of claim 16 wherein upon modification, the matched one of the plurality of templates allows mapping of all data fields in the EDI file.

19. The system of claim 16 wherein the mapping instructions include an aggregator string.

20. The system of claim 16 wherein the EDI file includes data related to: one or more device identifiers, usage associated with said one or more device identifiers and a phone number.
